(19) United States
(12) Patent Application Publication
(10) Pub. No.: US 2022/0132735 A1
(43) Pub. Date: May 5, 2022

(54) GRAIN MEASURING DEVICE, COMBINE, FIELD MANAGEMENT SYSTEM

(71) Applicant: Topcon Corporation, Itabashi-ku, Tokyo (JP)

(72) Inventor: Shugo AKIYAMA, Itabashi-ku, Tokyo (JP)

(73) Assignee: Topcon Corporation, Itabashi-ku, Tokyo (JP)

(21) Appl. No.: 17/310,222

(22) PCT Filed: Jan. 24, 2020
(86) PCT No.: PCT/JP2020/002524

§ 371 Date: Jul. 27, 2021

(30) Foreign Application Priority Data
Jan. 30, 2019 (JP) 2019-013892

(51) Int. Cl. A01D 41/127; G06V 20/40; G06V 20/68

(52) U.S. Cl. CPC A01D 41/1271; G06V 20/68; G06V 20/44

(57) ABSTRACT

A grain measuring device 10 includes a reaping determination unit 11 in a combine harvester 1 to determine a state of reaping grains; and a measurement unit 12 configured to measure a component of the grains and save a result of measurement when the reaping determination unit 11 determines that the combine harvester 1 is in in the state of reaping the grains.

### TECHNICAL FIELD

The present disclosure relates to a grain measuring device such as what is called a “protein sensor”, a combine harvester including the grain measuring device, and a field management system using the grain measuring device.

### BACKGROUND ART

In recent years, in the field of agriculture, there is a known method of measuring components such as nutritional values contained in harvested crops to measure the fertility or other characteristics of soil.

The information on the harvest points of the crops and the data on the measured nutritional values are associated with each other to create a map representing the distribution of fertility in the field and control the growth of the crops. For example, based on this map, additional fertilization, pesticide spraying, or other measures are taken to make the fertility uniform. This reliably provides crops uniform in quality at a stable yield.

There is a sensor (i.e., a protein sensor) that measures the content of protein among the nutrients contained in the crops, namely, grains.

There is a known method of mounting such a sensor on a harvester (i.e., a combine harvester) and measuring the nutrients of grains at the time of harvest (see e.g., Patent Document 1).

In addition, there is a known method of creating a map representing the distribution of the fertility in a field based on the information on the measured nutrients (see e.g., Patent Document 2).

### CITATION LIST

### Patent Documents

PATENT DOCUMENT 1: Japanese Unexamined Patent Publication No. 2014-67308

PATENT DOCUMENT 2: Japanese Unexamined Patent Publication No. 2016-171749

### SUMMARY OF THE INVENTION

### Technical Problem

In the measurement according to the Patent Document 1, however, when the combine harvester reaps no crops at the time of harvest (e.g., when the combine harvester moves in the field or cuts weeds at the ridges), the sensor continues the measurement processing even without reaping any grains such as wheat. Accordingly, unnecessary data (i.e., noise) other than the nutritional values is acquired, which degrades the measurement accuracy.

When the sensor continues the measurement processing, the measurement data is acquired also at the time of reaping no grains, which requires an enormous data capacity for storing the measurement results. In addition, the measurement results include the measurement data obtained while reaping no grains. This requires extra work such as removing such data to create a fertility map of the field, which degrades the work efficiency.

The present disclosure was made to solve the problems. It is an objective of the present disclosure to provide a grain measuring device, a combine harvester, and a field management system capable of improving the accuracy in measuring grains and the efficiency in data processing.

### Solution to the Problem

In order to achieve the objective, a grain measuring device according to the present disclosure is located in a combine harvester that reaps grains using a cutter and harvests the grains. The grain measuring device includes: a reaping determination unit configured to determine whether the combine harvester is in a state of reaping the grains; and a measurement unit configured to measure a component of the grains and save a result of measurement when the reaping determination unit determines that the combine harvester is in the state of reaping the grains.

The reaping determination unit determines whether the combine harvester is in the state of reaping the grains based on a cutting position or a standby position of the cutter.

The reaping determination unit determines the state of reaping the grains by detecting collision of kernels conveyed in the combine harvester.

The reaping determination unit captures an image of an inside of a path for conveying the kernels in the combine harvester, and determines the state of reaping the grains based on the image captured.

The reaping determination unit further includes:

a position information acquisition unit capable of acquiring position information; and

a storage unit configured to store the position information acquired by the position information acquisition unit and information on the component of the grains measured by the measurement unit.

In order to achieve the objective, a combine harvester according to the present disclosure includes the grain measuring device described above.

In order to achieve the objective, a field management system according to the present disclosure uses a grain measuring device in a combine harvester that reaps grains using a cutter and harvests the grains. The field management system includes: the grain measuring device including a reaping determination unit configured to determine whether the combine harvester is in a state of reaping the grains, a measurement unit configured to measure a component of the grains and save a result of measurement when the reaping determination unit determines that the combine harvester is in the state of reaping the grains, a position information acquisition unit capable of acquiring position information, and a storage unit configured to store the position information acquired by the position information acquisition unit and information on the component of the grains measured by the measurement unit; and a field evaluation unit configured to generate, for a field harvested by the combine harvester, a component distribution of the grains in the field based on the position information and the information on the component of the grains stored in the storage unit.

### Advantages of the Invention

The present disclosure using the unit described above improves the accuracy in measuring grains and the efficiency in data processing.

### BRIEF DESCRIPTION OF THE DRAWINGS

FIG. 1 is a schematic configuration diagram showing a configuration of a combine harvester including a grain measuring device according to an embodiment of the present invention.

FIG. 2 is a flowchart showing a method of measuring grains using the grain measuring device according to the embodiment of the present invention.

FIG. 3 is a schematic configuration diagram of a reaping determination unit of a grain measuring device according to a first variation.

FIG. 4 is a schematic configuration diagram of a reaping determination unit of a grain measuring device according to a second variation.

### DESCRIPTION OF EMBODIMENTS

An embodiment of the present invention will now be described with reference to the drawings.

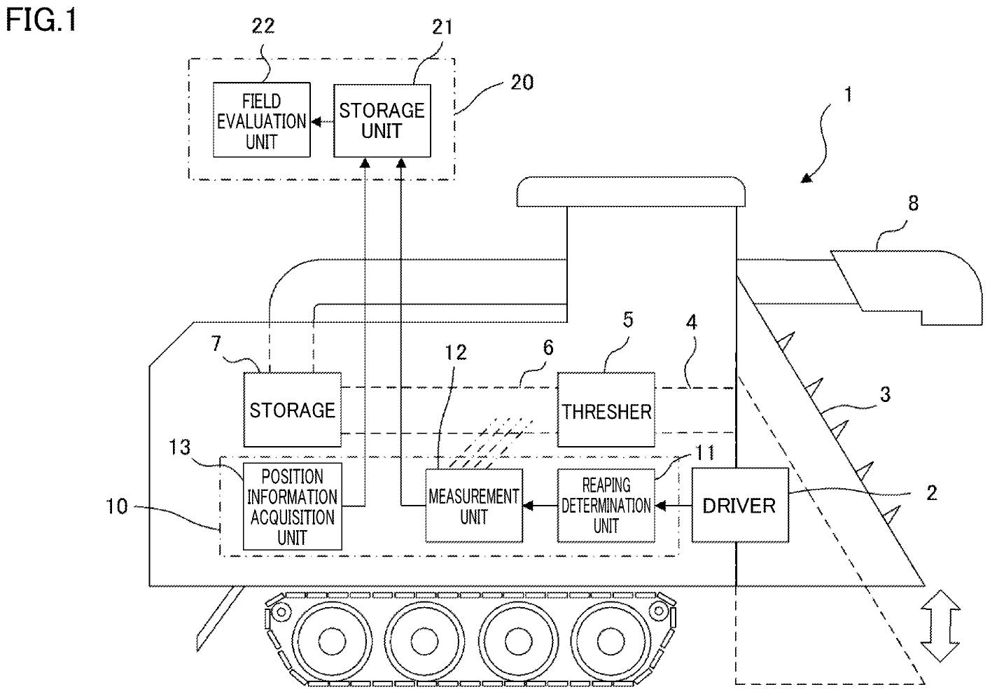

FIG. 1 shows a schematic configuration diagram of a combine harvester including a grain measuring device according to this embodiment. With reference to the diagram, the configuration according to the embodiment of the present invention will be described below.

As shown in FIG. 1, a combine harvester 1 is a crawler traveling, head feed combine harvester capable of self-traveling with a pair of right and left crawlers that are driven by an engine (not shown). Examples of the grains to be reaped and harvested by the combine harvester include grass such as wheat and rice.

This combine harvester 1 includes, at the front of the vehicle body, a cutter 3 movable up and down by a driver 2. The driver 2 is a hydraulic actuator, for example, movable up and down with respect to the cutter 3 between a cutting position indicated by a dotted line in FIG. 1 and a standby position indicated by a solid line.

At the cutting position, the cutter 3 cuts the straw of grains to be planted in a field and supplies the cut straw to a thresher 5 via a first conveyor 4. The cutter 3 includes a cutting blade and a receiving blade like a hair clipper (not shown), and cuts the crops at a height near the ground through the reciprocating motion of the cutting blade.

The combine harvester 1 lifts the cutter 3 up to the standby position not to hinder the travel while reaping no grains, and down to the cutting position when reaping grains. Such lift up and down of the cutter 3 through the driver 2 can be operated by a lifting lever (not shown). The driver 2 moves up and down in accordance with a binary drive signal transmitted from a control unit (not shown), for example, at 0 V when lifting up the cutter 3 and at 5 V when lifting down the cutter 3. When the drive signal indicates 5 V, it is thus determined that the cutter 3 is at the cutting position and the combine harvester 1 is in the state of reaping grains.

The first conveyor 4 is a conveyor chain or a rake-up belt, for example that aligns the grain straw cut by the cutter 3 and feeds the aligned grain straw to the thresher 5.

The thresher 5 includes a threshing cylinder (not shown) attached with a large number of threshing teeth. The threshing cylinder rotates to remove the grain straw and separate the kernels from the ears. The thresher 5 is connected to a storage 7 via a second conveyor 6.

The second conveyor 6 has a path for conveying, to the storage 7, the kernels obtained after the threshing. The second conveyor 6 may include, for example, a sorting mechanism for sorting the kernels out of the crops to be threshed.

The storage 7 is a tank that stores the kernels supplied from the second conveyor 6. The storage 7 is connected to a discharge auger 8 that discharges of the kernels stored in the storage 7 outside.

The combine harvester 1 includes a grain measuring device 10 for measuring the components of the reaped grains.

The grain measuring device 10 includes a computer including a CPU, a storage device, and sensors, and functionally includes a reaping determination unit 11, a measurement unit 12, a position information acquisition unit 13, and an external device 20 mainly.

The reaping determination unit 11 functions to determine whether the combine harvester 1 is in the state of reaping grains. Specifically, based on the drive signal of the driver 2, the reaping determination unit 11 determines that the combine harvester 1 is in the state of reaping grains when the cutter 3 is at the cutting position and not in the state of reaping grains when the cutter 3 is at the standby position.

The measurement unit 12 is a sensor that measures the components contained in the kernels obtained after the threshing and, in this embodiment, a protein sensor that measures the amount of protein. Specifically, the measurement unit 12 includes LEDs with four different wavelengths and is disposed in the path of the second conveyor 6. The measurement unit 12 can measure the protein content of the kernels by sequentially irradiating the kernels passing through the second conveyor 6 with measuring light from the LEDs, receiving the reflected light, integrating and averaging the amounts of the reflected light.

The position information acquisition unit 13 functions to acquire the position information on the combine harvester 1 and), for example, a global navigation satellite system (GNSS) receiver such as a global positioning system (GPS).

In this embodiment, a field management system including the external device 20 for the grain measuring device 10 outside the combine harvester 1.

The external device 20 is, for example, a personal computer or a tablet terminal including a storage unit 21 and a field evaluation unit 22.

The storage unit 21 is a storage medium that stores various data and, for example, a hard disk or a flash memory. Examples of the data include the measurement data (i.e., component information) on the protein of the kernels measured by the measurement unit 12 and the position information on the combine harvester 1 acquired by the position information acquisition unit 13. The storage unit 21 can acquire the information from the measurement unit 12 and the position information acquisition unit 13 via a wireless or wired communication unit or a detachable memory.

After the reaping in the target field, the field evaluation unit 22 can extract the histories of the measurement data and the position information stored in the storage unit 21 and generate the component distribution of the grains in the field. Specifically, the field evaluation unit 22 is an application program operated by a computer.

The combine harvester 1 with such a configuration including the grain measuring device 10 including the external device 20 stores the measurement data on the protein of the kernels measured by the measurement unit 12 and the position information in the storage unit 21 of the external device 20. The combine harvester 1 then evaluates the measurement data and the position information in the field evaluation unit 22, while or after the end of cutting the grains.

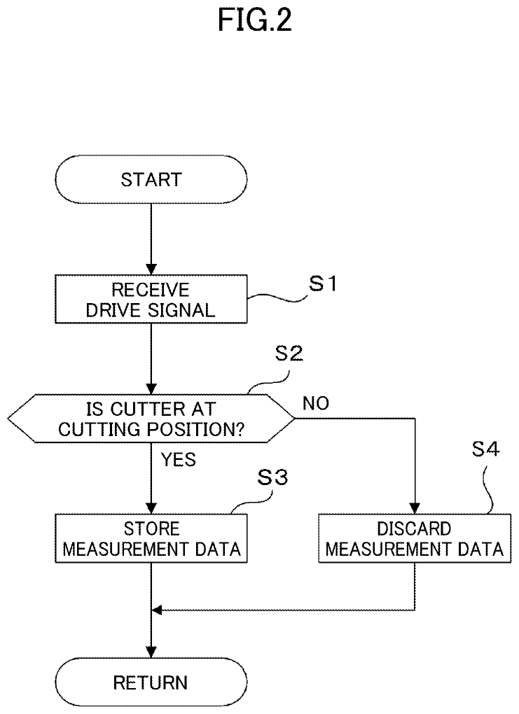

Next, refer to FIG. 2 that is a flowchart showing a grain measurement method using the grain measuring device 10. The grain measurement method will be described with reference to the flowchart.

First, as step S1, the grain measuring device 10 receives a drive signal from the driver 2 of the combine harvester 1, using the reaping determination unit 11.

Then, as step S2, the reaping determination unit 11 determines whether or not the combine harvester 1 is in the state of reaping grains, specifically, whether or not the cutter 3 is at the cutting position, based on the drive signal received in step S1. If the result of the determination is true (Yes), the process proceeds to step S3.

In step S3, the measurement unit 12 measures the protein of the kernels passing through the second conveyor 6 and stores the measured protein in the storage unit 13. This routine returns.

On the other hand, if the result of the determination in step S2 is false (No), that is, when the cutter 3 is at the standby position and unable to cut the grains, the process proceeds to the step S4.

In step S4, the measurement unit 12 discards the measurement data at this time, that is, stores no measurement data in the storage unit 21. This routine returns.

As described above, the grain measuring device 10 saves the data measured by the measurement unit 12 in the storage unit 21 only when the reaping determination unit 11 determines that the combine harvester 1 is in the state of reaping grains, and discards unnecessary data measured when the combine harvester 1 is not in the state of reaping grains. Accordingly, unnecessary data (i.e., noise) is not accumulated when reaping no grains, which improves the accuracy in measuring the components of the grains in the field. In addition, the data capacity required to store the measurement results in the storage unit 21 decreases, which reduces the work such as removing unnecessary data later and improves the work efficiency in the data processing.

In particular, in this embodiment, the reaping determination unit determines the cutting and standby positions of the cutter 3 based on the drive signals from the driver that lifts up and down the cutter, and thus easily determines whether the combine harvester 1 is in the state of reaping grains.

The grain measuring device 10 also includes the position information acquisition unit 13 and stores, together with the measurement data on the protein of the grains measured by the measurement unit 12, the position information in the storage unit 21. Accordingly, the position information and the protein data are associated with each other.

The combine harvester 1 including such a grain measuring device 10 efficiently reaps and harvests the grains, and measures the protein of the reaped grains (i.e., kernels).

The field management system including the field evaluation unit 22 generates the evaluation data such as the fertility map based on the protein of the grains in the field based on the histories of the position information and the protein data on the grains stored in the storage unit 21 for the field harvested by this combine harvester 1.

As described above, the grain measuring device, the combine harvester, and the field management system according to this embodiment improve the accuracy in measuring the grains and the efficiency in the data processing.

An embodiment of the present invention has been described above. The aspects of the present invention are, however, not limited to this embodiment.

In the embodiment described above, the reaping determination unit 11 determines whether the cutter 3 is at the cutting or standby position based on the drive signals of the driver 2. The unit for determining the cutting state of the cutter is however not limited thereto. For example, the cutter may include a sensor for directly detecting the cutting position to determine the position at which the cutting is possible.

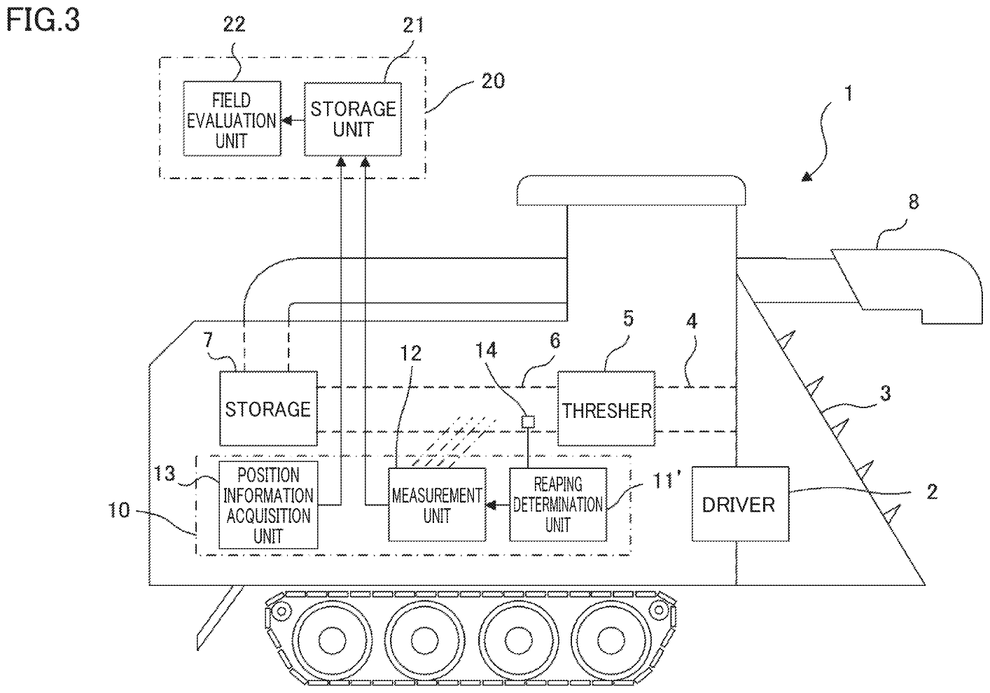

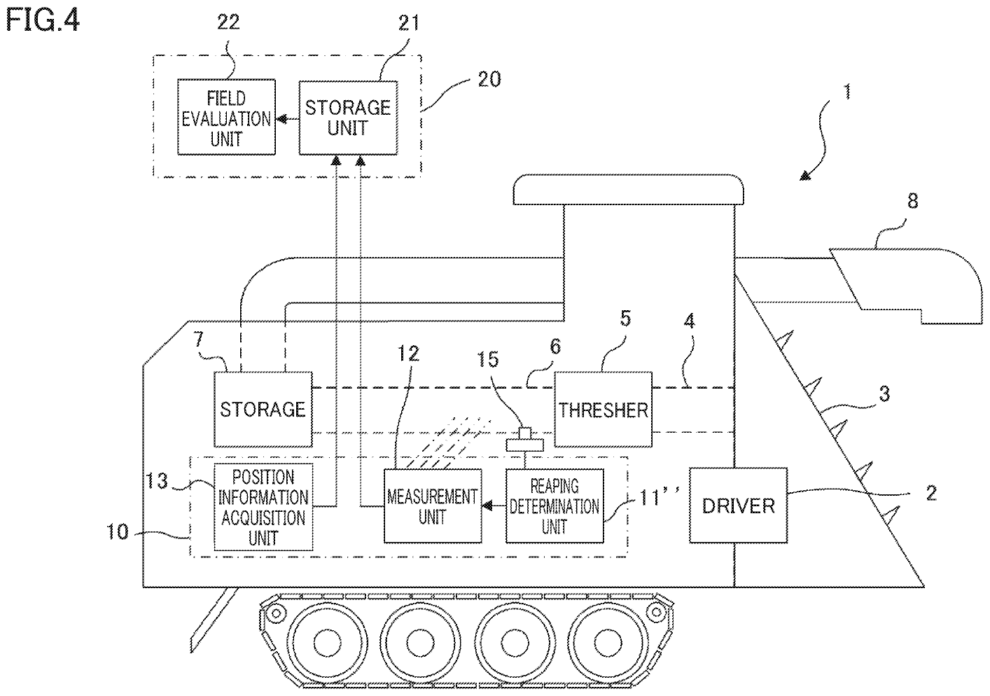

FIGS. 3 and 4 show first and second variations of the reaping determination unit, respectively. The same reference characters as those in the embodiment described above are used to represent equivalent elements. The position information acquisition unit and the field evaluation unit are omitted for the sake of simplicity.

In the first variation shown in FIG. 3, the second conveyor 6 includes a collision sensor 15 that detects collision of the kernels. Connected to the collision sensor 14 is a reaping determination unit 11′. Once the combine harvester 1 reaps the grains whose kernels are actually carried to the second conveyor 6, the kernels collide with the collision sensor 14 and a signal indicating the collision is sent to the reaping determination unit 11′. Upon receipt of the signal, the reaping determination unit 11′ determines that the combine harvester 1 is in the state of reaping grains.

In the second variation shown in FIG. 4, the second conveyor 6 includes, in its conveying path, a camera 15 which is connected to a reaping determination unit 11″. The camera 15 captures moving images or periodically capture still images of the inside of the conveying path. The reaping determination unit 11″ detects the flow of the kernels by analyzing the images (i.e., the moving or still images) captured by the camera 15. If the kernels flow, the reaping determination unit 11″ determines that the combine harvester 1 is in the state of reaping the grains.

As described above, the reaping determination units according to the first and second variations determine that the kernels actually pass through the second conveyor regardless of the position of the cutter, and save only the results of measurements at the time. That is, highly accurate and efficient grain measurement is possible. Note that the reaping determination unit may combine a plurality of determinations such as the determination using the driver as in the embodiment described above, the determination using the collision sensor as in the first variation, and the determinations based on the images as in the second variation.

In the embodiment described above and the first and second variations, the storage unit 21 and the field evaluation unit 22 are located outside the combine harvester 1. The present invention is however not limited to this configuration. For example, at least the storage unit may be included in the grain measuring device in the combine harvester, and the field evaluation unit may be located outside. Alternatively, both the storage unit and the field evaluation unit may be included in the grain measuring device in the combine harvester.

### DESCRIPTION OF REFERENCE CHARACTERS

1 Combine Harvester
2 Driver
3 Cutter
4 First Conveyor
5 Thresher
6 Second Conveyor
7 Storage
10 Grain Measuring Device
11, 11′, 11″ Reaping Determination Unit
12 Measurement Unit
13 Position Information Acquisition Unit
14 Collision Sensor
15 Camera
20 External Device
21 Storage Unit
22 Field Evaluation Unit

1. A grain measuring device in a combine harvester that reaps grains using a cutter and harvests the grains, the grain measuring device comprising:
a reaping determination unit configured to determine whether the combine harvester is in a state of reaping the grains; and
a measurement unit configured to measure a component of the grains and save a result of measurement when the reaping determination unit determines that the combine harvester is in the state of reaping the grains.

2. The grain measuring device of claim 1, wherein
the reaping determination unit determines whether the combine harvester is in the state of reaping the grains based on a cutting position or a standby position of the cutter.

3. The grain measuring device of claim 1, wherein
the reaping determination unit determines the state of reaping the grains by detecting collision of kernels conveyed in the combine harvester.

4. The grain measuring device of claim 1, wherein
the reaping determination unit captures an image of an inside of a path for conveying the kernels in the combine harvester, and determines the state of reaping the grains based on the image captured.

5. The grain measuring device of claim 1, further comprising:
a position information acquisition unit capable of acquiring position information; and
a storage unit configured to store the position information acquired by the position information acquisition unit and information on the component of the grains measured by the measurement unit.

6. A combine harvester comprising the grain measuring device of claim 1.

7. A field management system using a grain measuring device in a combine harvester that reaps grains using a cutter and harvests the grains, the field management system comprising:
the grain measuring device including a reaping determination unit configured to determine whether the combine harvester is in a state of reaping the grains, a measurement unit configured to measure a component of the grains and save a result of measurement when the reaping determination unit determines that the combine harvester is in the state of reaping the grains, a position information acquisition unit capable of acquiring position information, and a storage unit configured to store the position information acquired by the position information acquisition unit and information on the component of the grains measured by the measurement unit; and
a field evaluation unit configured to generate, for a field harvested by the combine harvester, a component distribution of the grains in the field based on the position information and the information on the component of the grains stored in the storage unit.

8. The grain measuring device of claim 2, wherein
the reaping determination unit determines the state of reaping the grains by detecting collision of kernels conveyed in the combine harvester.

9. The grain measuring device of claim 2, wherein
the reaping determination unit captures an image of an inside of a path for conveying the kernels in the combine harvester, and determines the state of reaping the grains based on the image captured.

10. The grain measuring device of claim 3, wherein
the reaping determination unit captures an image of an inside of a path for conveying the kernels in the combine harvester, and determines the state of reaping the grains based on the image captured.

11. The grain measuring device of claim 2, further comprising:
a position information acquisition unit capable of acquiring position information; and
a storage unit configured to store the position information acquired by the position information acquisition unit and information on the component of the grains measured by the measurement unit.

12. The grain measuring device of claim 3, further comprising:
a position information acquisition unit capable of acquiring position information; and
a storage unit configured to store the position information acquired by the position information acquisition unit and information on the component of the grains measured by the measurement unit.

13. The grain measuring device of claim 4, further comprising:
a position information acquisition unit capable of acquiring position information; and
a storage unit configured to store the position information acquired by the position information acquisition unit and information on the component of the grains measured by the measurement unit.

14. A combine harvester comprising the grain measuring device of claim 2.

15. A combine harvester comprising the grain measuring device of claim 3.

16. A combine harvester comprising the grain measuring device of claim 4.

17. A combine harvester comprising the grain measuring device of claim 5.
